(19) United States
(12) Patent Application Publication
(10) Pub. No.: US 2011/0231517 A1
(43) Pub. Date: Sep. 22, 2011

(54) Smart download system for mobile devices with multiple data interfaces using enhanced HTTP proxy server

(76) Inventors: Sudharshan Srinivasan, Fremont, CA (US); Kothandraman Ramchandran, Fremont, CA (US); Jai Kumar, Cupertino, CA (US)

(21) Appl. No.: 12/661,653

(22) Filed: Mar. 20, 2010

(51) Int. Cl. G06F 15/16

(52) U.S. Cl. 709/219

(57) ABSTRACT

A smart download system is described that enables partitioning of data downloads from internet into a mobile device (31) using multiple hardware data interfaces in mobile device (31).

In this system, a hyper text transfer protocol proxy server (36) is coupled to a download scheduler (37) in the mobile device (31), so that a user can schedule downloads based on certain conditions and associate these conditions with one or more data interfaces in the mobile device (31).

When a condition is satisfied, the interface associated with this condition is activated to begin downloading of data and store the data in storage in the mobile device or pass it directly to an application that can consume internet data such as a browser application.

The ability to configure data downloads to one or more data interfaces based on conditions enables efficient download of internet data across different interfaces and hence improves the overall efficiency of the system.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to data download systems for mobile devices and specifically to data download systems using HTTP (hyper text transfer protocol) proxy servers.

2. Prior Art US Patent

Mobile devices have evolved from single purpose devices to multipurpose devices. Mobile devices such as basic mobile phones provide communication functionality that have limited set of data interfaces. But smartphones that are mobile phones enhanced with general purpose processors, can execute several software programs and interact with internet data using multiple data interfaces.

Most smartphones communicate with internet data using HTTP protocol which is primarily a text based protocol that can carry a binary payload. But since HTTP protocol is built on top of TCP IP (transmission control protocol internet protocol), internet data access can be through any physical data interface that can support TCP IP. Hence it can be seen that a smartphone provides internet data access using one or more of the following data interfaces including cellular packet data interface, wireless local area network interface (wifi), bluetooth wireless interface, universal serial bus interface (USB), and ethernet interface.

Each of these interfaces is differentiated using two important attributes namely quality of service and cost structure. Quality of service provides different bandwidth and latency metrics depending on application needs, and cost structure offers different pricing schemes depending on the interfaces used. A cellular wireless data interface may cost more during peak data traffic times and cost less when there is not much traffic. A wife system may be free if it is at home but may require subscription fees when in a commercial location.

A smartphone that partitions data download across different interfaces based on the above mentioned attributes is not known to exist. All smartphones or mobile devices that use a browser to download internet data, download all of the data using currently available interface. There is no system in prior art that can schedule downloads for future time slots based on configurable conditions that can be associated with data interfaces and then present a user with a combination of data downloaded in real time and data that is downloaded according to a preset schedule.

Such a system that allows partitioning and mapping of data to different data interfaces will improve the usability of the smartphone and improve the efficiency of data networks.

This system should show to a user, a combination of data downloaded in real time and data that is downloaded at other times. Such a system should also enable a user to easily map downloads to appropriate data interfaces and schedules, based on configurable criteria.

For example, a HTML page containing stock market information may have stock quotes and a video about a company. If a smartphone user is connected to the internet using a cellular interface, then the user should be allowed to choose parts of the page that can be downloaded using cellular connectivity and parts of the page to be downloaded at other times using other interfaces. It is possible that the user may or may not want to download the video using cellular bandwidth based on cost of cellular data access.

As another example, if a mobile user wants to download a high definition video that is part of a website, he may choose to schedule it for later download even if the user has subscription to unlimited data plan using cellular data interface. This is because a high definition video may require bandwidth that is beyond what can be supported using a cellular network interface. He may choose to download this video using USB or wife interface at a later point in time.

Similarly, a user may want to download only textual content using cellular data interface and schedule download of image content to a later point in time, hence allowing the best possible use of data interfaces that balance cost, timeliness and quality of service.

Hence having ability to partition interne data, and scheduling downloads across appropriate data interfaces, is critical to improving the efficiency of the overall system and corresponding data networks used.

Such a system is not known to exist as most mobile devices use HTML browsers to access internet data. None of the HTML browsers in state of the art provide functionality to schedule downloads at a later point in time and then combine downloaded data based on a schedule with data downloaded in real time. To implement this feature in a browser it would be necessary to run a browser in daemon or background mode, which is not supported by any of browsers in state of the art and even when implemented, can lead to security problems. Also, for mobile devices where battery usage is critical, executing a browser in daemon mode or in background can drain the battery at a much faster rate. Browser software uses large amounts of memory and consumes a lot of processing power leading to increased battery consumption. In addition, most mobile device browsers are not extensible and hence this system cannot be easily implemented as a browser solution.

Hence there is a need for a system that enables a user to easily schedule data downloads to appropriate data interfaces and view a combination of data downloaded using different interfaces at different points in time without depending on the browser software.

It is to be noted that such a system that enables data partitioning across data interfaces in context of a single HTML page is equally applicable to data across multiple pages.

There are several solutions in prior art that address some parts of the requirement but none in isolation or in combination offer a solution to the above mentioned requirement, which is, an ability for a mobile device to schedule data downloads to different data interfaces based on user specified criteria and then combine all the data downloads into a single combined view.

Inability to map data downloads to different data interfaces leads to inefficient use of bandwidth and usability for a user.

Currently there are no known prior art methods that offer a solution to this problem.

Following paragraphs in current section describe relevant prior arts in this field.

Prior art US Doc 20090280784 proposes using a server that receives request from a mobile device for streaming data to be pushed to the mobile device at off peak times, but this does not address the need to map a particular data download to a particular data interface. Mapping to just time intervals is insufficient as a data interface that is expected to be available at a particular time may not be available.

Also, this does not address the usability issue of showing in a browser, data that is scheduled for download in comparison with data that can be downloaded in real time.

In addition, in this solution there is a need for a server outside of the mobile device, that stores the user requirements about download time intervals, but there is no mention of how this server will be notified from the mobile device when a particular data interface is available or not available at the mobile device. The only way this system will work is if the server were to be notified every time there is a new data interface available, but this will be very expensive and non scalable across a cellular wireless data network. Hence this system does not provide a solution where data downloads are partitioned across different data interfaces based on user requirements and availability of data interfaces, but just uses time intervals which is not sufficient to provide the best user experience and efficient use data networks.

Prior art US Doc 20100011121 proposes using a proxy server in a mobile device to enable data compression to and from the mobile device. This system addresses the needs of a cellular data system, where bandwidth usage is to be reduced. But this does not address the need where data downloads can be scheduled and mapped to multiple data interfaces, and also does not provide a way for a user to view and schedule data downloads using multiple interfaces.

Also combining the above two will still not result in satisfying all the requirements addressed by present invention. In particular combining the proxy server on the device with a compression and data push engine at the server is still not sufficient to figure out which data interface is to be used when, and how a user can setup a mapping of different data downloads to different interfaces.

Prior art US Doc 20040012625 proposes a system using a proxy server for downloading data for offline use. This only addresses the need for bulk download of data, so that a user is able to consume data when there is no network access. But this does not address the need where a user may want to consume data that is downloaded already along with data that can be seen in real time. This also does not address the need where a user is able to schedule downloads across different interfaces. In order to support such a feature, a basic proxy server that supports bulk downloads is not sufficient.

Prior art U.S. Pat. No. 6,771,948 proposes using background data downloads when the network is not being used but is already paid for. This system would be useful only in data networks that use circuit switched cellular networks for data access. But this system does not address any of the requirements stated above that enable scheduling data downloads across multiple data interfaces at appropriate times.

Prior art U.S. Pat. No. 5,948,066 proposes a proxy server use in a mobile device that reduces multiple round trips to access a complete web page that might contain image references that are usually retrieved using independent requests. But this does not address the need to use multiple data interfaces that are available in current generation smartphones.

As can be seen from above, all known prior arts suffer from some limitations in offering a solution to address the need for a system that enables a mobile device user to partition and schedule data downloads across multiple data interfaces based on configurable criteria.

### OBJECTS AND ADVANTAGES

Accordingly, several objects and advantages of the present invention are:
a) to provide a smart download system that provides a user interface to a user of a mobile device, that allows a user to schedule and map data downloads of internet data to multiple data interfaces available in the mobile device;
b) to provide a combined view of data downloaded using one or more of available data interfaces along with data that is downloaded in real time; and
c) to provide a software module that enables mapping of download schedules to data interfaces based on interface availability and other criteria.

### SUMMARY

In accordance with present invention a smart download system is provided that enables a user to schedule downloads across multiple data interfaces in a mobile device and view a combination of data that is downloaded using preset schedules and data that is downloaded in real time.

This is achieved by providing a mobile device with a HTTP proxy server that is enhanced with a schedule manager software module, a data interface listener software module, a data transformation module, a data download manager software module, a user interface enhancement module, and a data combining module.

A schedule manager software module enables scheduling of data downloads using any of the available interfaces. This could allow a user to schedule downloads when more bandwidth is available, or when the cost of such bandwidth is low.

A data interface listener software module enables the proxy server to listen to events from different interfaces to know when each of the interfaces is available and launch a download if necessary.

A data transformation module enables the proxy server to modify any interne data to add information about already downloaded data or modify the appearance of existing data to indicate what kind of data download is scheduled on such data.

A data download manager software module enables the proxy server to manage downloads. This provides an ability to recover from partial downloads and keep track of what needs to be downloaded when and with what interface.

A user interface enhancement module enables the proxy server to add additional user interface elements to a web page to enable a user to setup download schedules and show progress of any of the downloads. This module may change universal resource locator link colors in an html page to indicate that some data is scheduled for download using a particular interface or add new icons or menu items to indicate the same.

A data combining module enables combining data from multiple downloads into a single html page. Hence when a user requests a page, part of the page may be produced using pre downloaded data and part of the page may be retrieved in real time. This enables downloading only the textual content and fitting into already downloaded chrome of any web page. A chrome is the drawing style information that is associated with any web page, that may include tables, divisional elements, colors and links. By just downloading text and combining with chrome saves a lot of bandwidth since most web sites do not change their chrome that often.

Hence enhancing a proxy server in a mobile device with a schedule manager that maps download requests to appropriate data interface, and a data interface listener to know when a particular data interface is available for use and a user interface enhancement module, provides an unobvious result of partitioning data downloads between real time and non real time data thus increasing the efficiency of cost sensitive data networks such as cellular data networks.

### DRAWINGS—FIGURES

FIG. 1 shows an end to end system of present invention where a mobile device uses an enhanced proxy server to schedule downloads across multiple data interfaces to retrieve data from a web server in the internet.

FIG. 2 shows embodiments of the mobile device.

FIG. 3 shows embodiments of download conditions.

FIG. 4 shows embodiments of data interface.

FIG. 5 shows details of the mobile device of present invention.

FIG. 6 shows a flow chart of mobile device receiving data using real time and scheduled data connections and combining these kinds of data to show a combined view to a user.

FIG. 7 shows a diagram of a use case scenario for creating download schedule on a web browser.

FIG. 8 shows a diagram of a use case scenario for viewing download schedule on a web browser.

FIG. 9 shows a diagram of a use case scenario for editing download schedule list on a web browser.

### DRAWINGS—Reference Numerals

31 mobile device
32 internet
33 local area network communication link
34 wide area network communication link
35 web server
36 hyper text protocol (HTTP) proxy server
37 download scheduler
38 web browser application
39 data download conditions
40 timer expiry condition
41 data interface availability condition
42 global positioning system coordinate match condition
43 data interface pricing condition
44 data interface quality of service availability condition
45 data interface
46 cellular packet data interface
47 wireless local area network interface
48 bluetooth wireless interface
49 universal serial bus interface
50 ethernet interface
51 local area networking interface
52 wide area networking interface
53 data interface listener
54 data transformer
55 download manager
56 user interface enhancer
57 data combiner
58 personal digital assistant
59 midrange mobile phone
60 smart phone
61 portable media player
62 step
63 step
64 step
65 step
66 step
67 step
68 step
69 step
70 web browser page
71 display schedule selection matrix
72 location bar
73 webpage text
74 static window
75 streaming window
76 universal resource locator link
77 download schedule list icon
78 boldface and colored text
79 italicized text
80 video controls
81 download schedule list
82 universal resource locators column
83 condition column
84 interface column

### DETAILED DESCRIPTION OF PREFERRED EMBODIMENT

In the following description, first an end to end system is described that couples the mobile device of present invention with internet data servers to provide a user with an ability to schedule data downloads across multiple data interfaces associated with the mobile device. Then details of the mobile device internals are described followed by a method used to partition and download real time and non real time data.

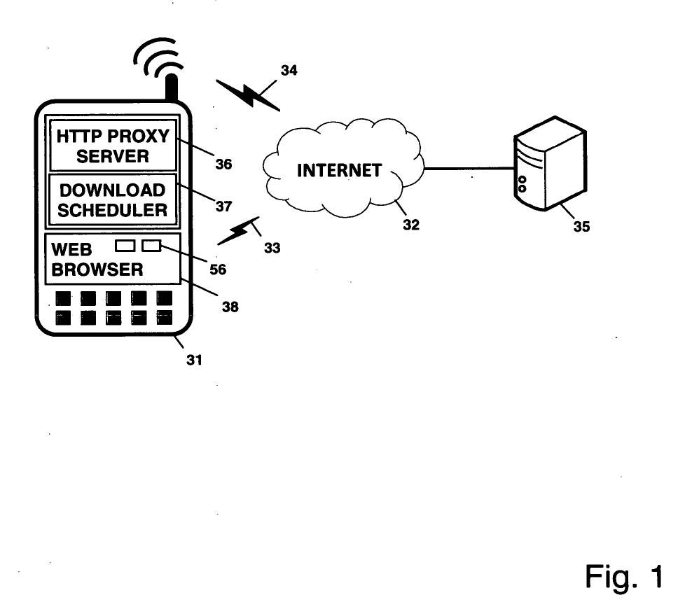

FIG. 1 shows end to end system where an mobile device 31 of present invention connects to internet 32 using one of several communications links such as local area network communication link 33 or a wide area network communication link 34. Internet 32 is connected to a web server 35 that provides web pages in response to requests from mobile device 31.

Mobile device 31 contains a hyper text protocol (HTTP) proxy server 36, that is coupled to a download scheduler 37.

A request from a web browser application 38 is received into HTTP proxy server 36, that is then sent to web server 35.

Proxy server 36 provides a user with user interface enhancements that enable scheduling of downloads. Such enhancements may be part of received hyper text markup language (HTML) data or can be provided as a separate user interface.

This system enables a user to schedule download of internet data using one or more of data interfaces that are part of mobile device 31. These downloads are scheduled based on data download conditions 39. If the condition is satisfied then a download is activated. A data download condition 39 can be made up of one or more of the following conditions such as timer expiry condition, data interface availability condition, global positioning system coordinate match condition, data interface pricing condition and data, interface quality of service availability condition.

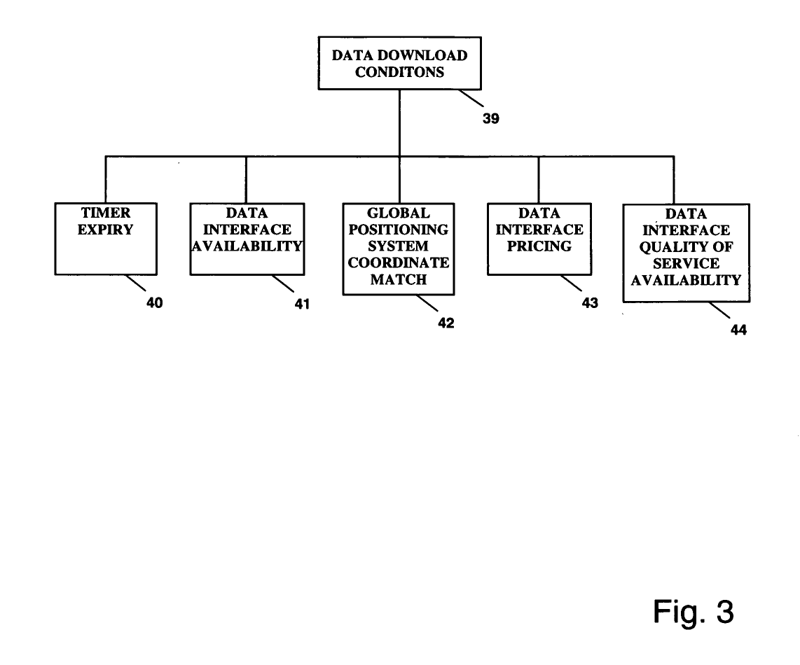

FIG. 3 shows that data download conditions 39 can be one of timer expiry condition 40, data interface availability condition 41, global positioning system coordinate match condition 42, data interface pricing condition 43 and data interface quality of service availability condition 44. Timer expiry condition 40 is satisfied when a download is scheduled for a particular time interval and that time interval has expired. Data interface availability condition 41 is satisfied when a data interface is available for use and download can be scheduled through it. Global positioning system coordinate match condition 42 is satisfied when mobile device 31 is at a particular location. Data interface pricing condition 43 is satisfied when mobile device 31 has access to an interface whose pricing attributes match user settings and data interface quality of service condition 44 is satisfied when an interface is available with desired bandwidth and latency.

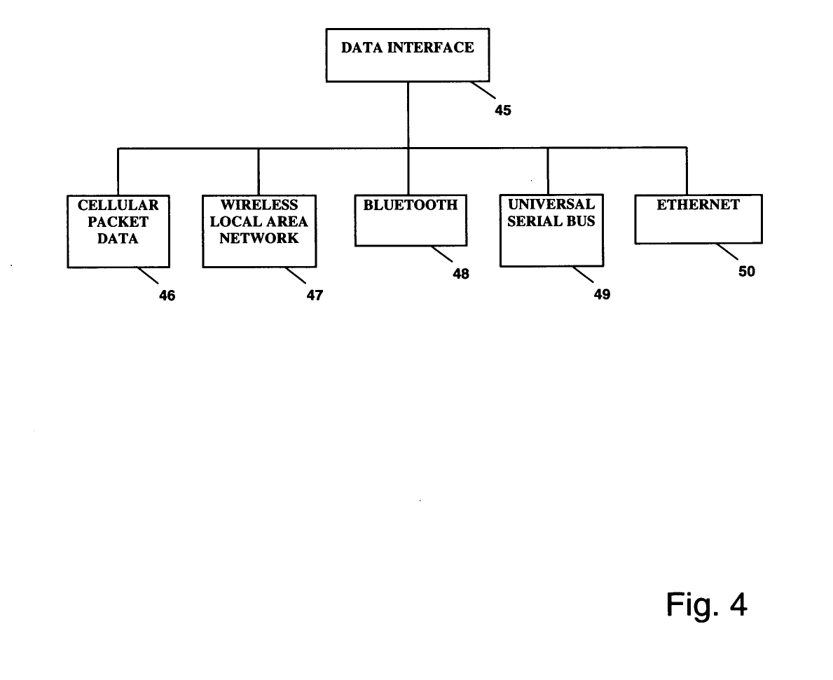

FIG. 4 shows that data interface 45 can be one of cellular packet data interface 46, wireless local area network interface 47, bluetooth wireless interface 48, universal serial bus interface 49, and ethernet interface 50.

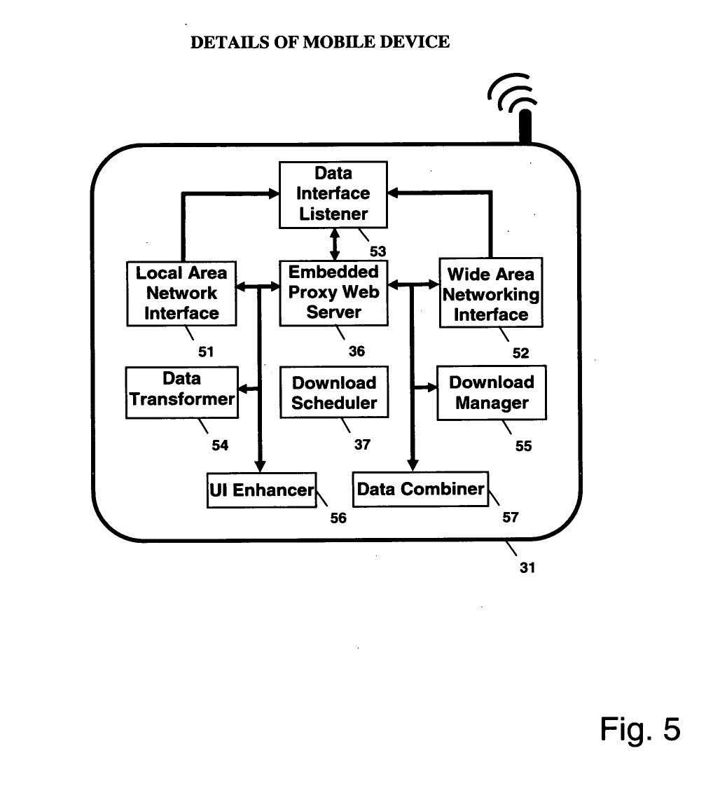

FIG. 5 shows details of mobile device 31. It includes local area networking interface 51, wide area networking interface 52, a HTTP proxy server 36, data interface listener 53, download scheduler 37, data transformer 54, download manager 55, user interface enhancer 56, and data combiner 57.

Local area networking interface 51 enables mobile device 31 to connect to internet 32 using local area networking such as wireless fidelity (wifi) or universal serial bus (USB) or ethernet.

Wide area networking interface 52 enables mobile device 31 to connect to internet 32 using wide area networks such as cellular data networks.

HTTP proxy server 36 is coupled to download scheduler 37. Download scheduler 37 enables scheduling of downloads based on configurable conditions. HTTP proxy server 36 is also coupled with data interface listener 53 so that any events from data interfaces can be acted upon. Data interfaces in mobile device 31 are capable of generating events that can be acted upon by download scheduler. These events can indicate availability or unavailability of a particular interface, or interruption and completion of data requests.

Data transformer 54 transforms incoming data from internet so that each universal resource locator link may be modified to indicate if the data downloaded corresponding that link is already available or scheduled for download and on a particular interface.

Download manager 55 manages scheduled downloads to keep track of which downloads are completed and which are pending and if any are interrupted and if they are to be resumed when conditions in downloads scheduler are met again.

User interface enhancer 56 provides user interface enhancements to a user either inside of data that is retrieved from internet 32, or as a separate HTML page to enable scheduling and tracking downloads. These enhancements could provide checkboxes on top of each universal resource locator in a web page to schedule or cancel downloads, provide icons to indicate which data interface is to be used, and provide other user interface elements that enable setting up conditions for each of the downloads.

Data combiner 57 combines data that is retrieved in real time with data that is already downloaded. This gives a user a combined view of all download data.

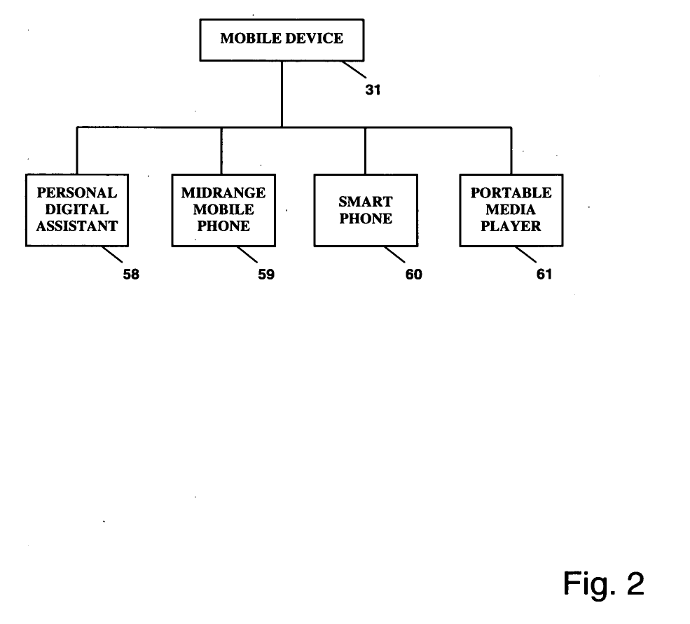

FIG. 2 shows that mobile device 31 can be one of personal digital assistant 58, midrange mobile phone 59, a smart phone 60, and a portable media player 61 and any mobile device that supports a standard web browser and network interface to get HTML pages.

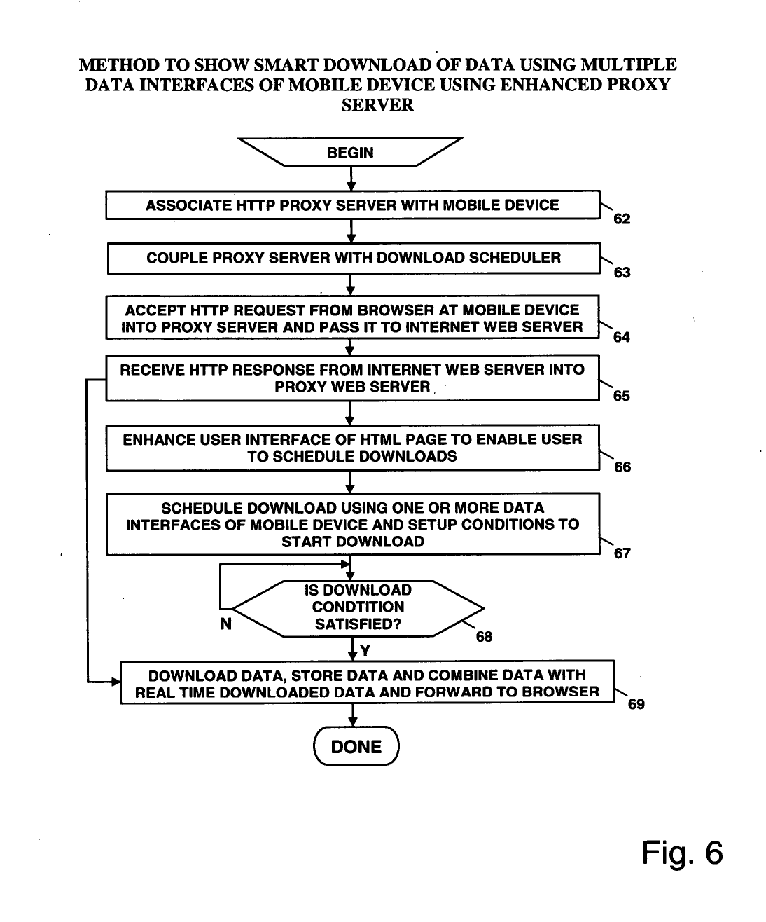

FIG. 6 shows a flow chart of a method to schedule download of interne data using system of present invention.

In step 62 mobile device 31 is associated with HTTP proxy server 36.

In step 63, HTTP proxy server 36 is coupled with download scheduler 37.

In step 64 a HTTP request from web browser 38 in mobile device 31, is accepted at HTTP proxy server 36 and this request is passed to web server 35.

In step 65 response from web server 35 is received into HTTP proxy server 36.

In step 66 this response is changed to introduce user interface enhancements so that a user can schedule downloads of embedded universal resource locator links, and indicate if certain links are already downloaded.

In step 67 a user schedules a download by mapping the desired download to appropriate data interface 53. The download is scheduled based on download conditions. A download is activated only if desired set of conditions is satisfied. The download conditions can be one or more of the following conditions including timer expiry condition, data interface availability condition, global positioning system coordinate match condition, data interface pricing condition, and data interface quality of service availability condition.

In step 68 a check is done to see if the desired condition is satisfied.

In step 69 data download is activated if the above check is successful and data that is received at HTTP proxy server 36, is either stored at a data storage in mobile device 31, or is forwarded to web browser 38 with no modifications or is modified and combined with data that is downloaded before the current download, or is modified and combined with data that is retrieved in real time.

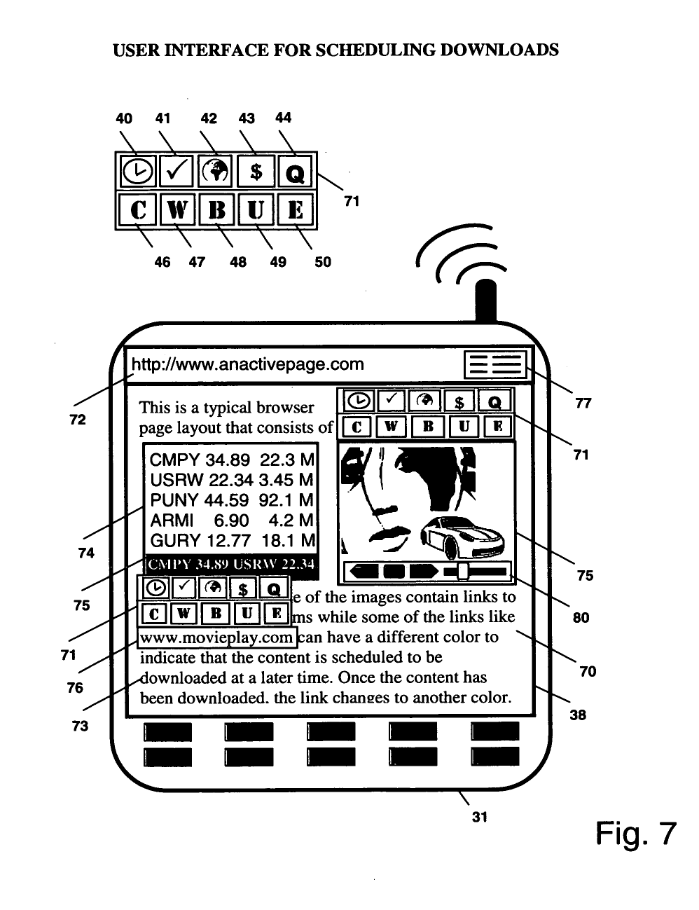

FIG. 7 shows a diagram of a use case scenario in which user interacts with new user interface elements in web browser to setup download schedules. web browser page 70 is modified to contain icons and visual cues to assist user in creating a schedule of downloads for different elements in web browser page 70. A display schedule selection matrix 71 can be associated with each element on browser page that needs to be scheduled for download. Display schedule selection matrix 71 is comprised of options that a user can choose from to schedule a download. These options are divided into two categories of options as two rows. The top row lists options that pertain to data download conditions 39. The bottom row lists options that correspond to data interfaces 45 a user can choose from, to perform downloads. Data download conditions 39 can be one of timer expiry condition 40, data interface availability condition 41, global positioning system coordinate match condition 42, data interface pricing condition 43, and data interface quality of service availability condition 44. User can select one or more options from list of data download conditions 39. By selecting timer expiry condition 40 option, user can set a date and time in the future when download needs to take place. Data interface availability condition 41 allows user to choose a data interface when it becomes available to use. By selecting this option, user has to select one of available data interface options from second row in display schedule matrix 71. For setting a global positioning system coordinate match condition 42, user is shown a map or a list of locations to choose from. For example, location condition or zone can be chosen from a list of well known coffee shops that provide free wifi download support. When mobile device 31 enters selected zone, download condition is triggered. Data interface pricing condition 43 allows a user to set data downloads when certain pricing conditions are met. For example, a user can indicate that downloads have to be triggered when cost of data download per kilobyte falls below a threshold dollar value anytime during the day or night. Data interface quality of service condition 44 is set to indicate availability of desired bandwidth and latency metrics. In this case, user is willing to pay a premium for guaranteed quality of data download service.

Data interface 45 options allows a user to select a suitable interface for downloading data from one of cellular packet data interface 46, wireless local area network interface 47, bluetooth wireless interface 48, universal serial bus interface 49, and ethernet interface 50. User can click on one or more of icons representing each of the interfaces. When one of the conditions from data interface availability condition 41 is triggered, then data download takes place immediately through any one of the selected and available data interfaces 45.

On any web browser page 70, a user can activate display schedule selection matrix 71 on any link in web browser page 70 including link of currently loaded page that is shown in location bar 72 of web browser 38. In this figure, webpage text 73 is interspersed between images and windows containing fixed graphics referred to as static window 74 or windows containing streaming graphics referred to as streaming window 75. One or more links associated with static window 74 or streaming window 75 can be scheduled for download.

For example, by moving mouse over universal resource locator link 76, display schedule selection matrix 71 pops up to recommend that the link be scheduled for downloading. Similarly, list of scheduled downloads can be found by clicking download schedule list icon 77.

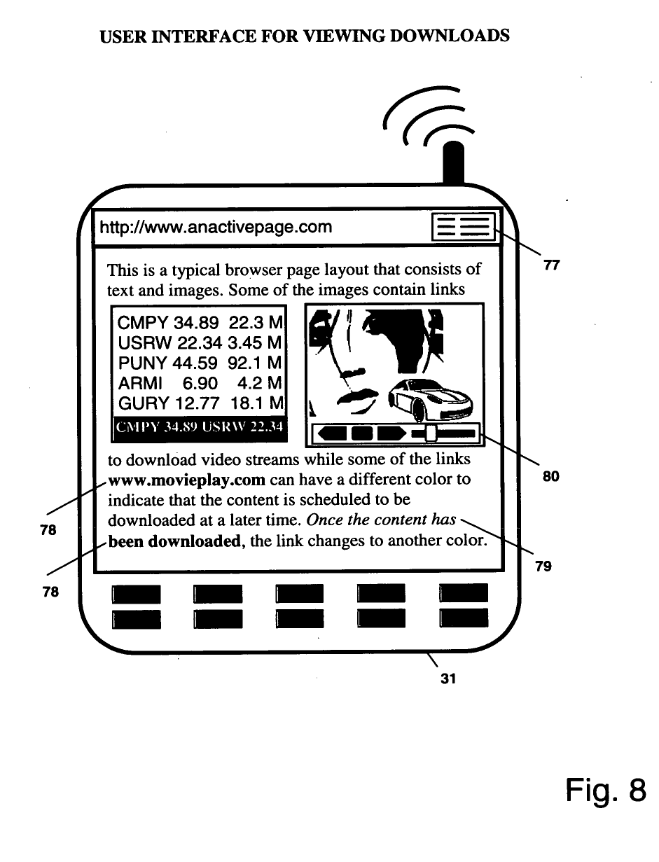

FIG. 8 shows a diagram of a use case scenario in which a user interacts with new user interface elements in web browser 38 to view data that has been downloaded. Web browser page 70 displays different cues to indicate status of downloads. Certain portions of web page can have boldface and colored text 78 to indicate a successful download or can have italicized text 79 to indicate that the link has been scheduled for download. For video downloads; video can be played using video controls 80 only after download has been successful. If download has been scheduled but not taken place as yet, video controls 80 are disabled and cannot be used. Also, suggestions for downloadable content are made using different combinations of user interface elements.

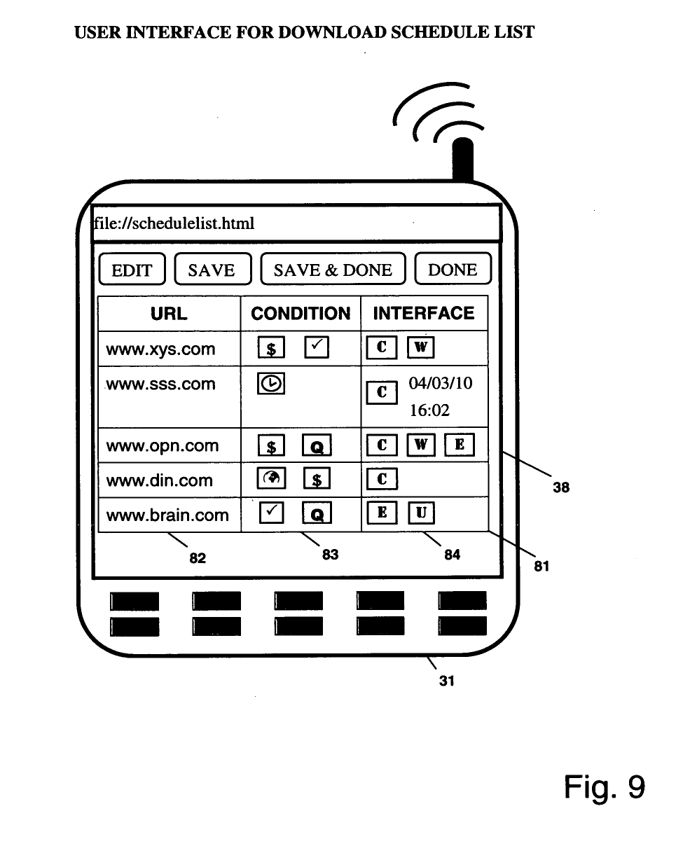

FIG. 9 shows a diagram of download schedule list 81 of elements that are scheduled for download. This page is shown to user when download schedule list icon 77 is selected from any web page. Universal resource locators that have been captured through the scheduling process are listed in universal resource locators column 82. Conditions for scheduling are listed in condition column 83 for each of universal resource locator entry. Combinations of interface options are listed in interface column 84. All columns can be sorted in ascending or descending order to view information better. Once user exits from this page, control is passed back to web browser page 70 from which download schedule list icon 77 was selected.

### Advantages

From the description above a number of advantages of this interactive radio system become evident:
a) a smart download system is provided, that provides a user interface to a user of a mobile device, that allows a user to schedule and map data downloads of interne data to one or more data interfaces available in the mobile device;
b) a combined view of data is provided, of data downloaded using one or more of available data interfaces along with data that is downloaded in real time; and
c) a software module is provided, that enables mapping of download schedules to data interfaces based on interface availability and other criteria.

### CONCLUSION, RAMIFICATIONS AND SCOPE

Accordingly, the reader will see that combining a combining proxy server with a schedule manager software module, a data interface listener software module, a data transformation module, a data download manager software module, a user interface enhancement module, and a data combining module provides an unobvious result of partitioning data downloads between real time and non real time data, thus increasing the efficiency of cost sensitive data networks such as cellular data networks.

Without such extensions to proxy server a user will not be able to effectively schedule downloads across different network interfaces causing unnecessary data downloads.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A smart download system coupling a mobile device to interne data, for efficient download of said data across plurality of data interfaces of said mobile device, comprising:
a hyper text transfer protocol proxy server at said mobile device;
a schedule manager software module coupled to said proxy server at said mobile device;
and a interne data server such as a web server coupled to internet.

2. The smart download system of claim 1,
wherein said mobile device is selected from group consisting of personal digital assistant, smartphone, midrange mobile phone, and portable media player.

3. The smart download system of claim 1,
further comprising:
a data interface listener software module coupled to said proxy server and said data interfaces.

4. The smart download system of claim 3,
further comprising:
a data download manager software module coupled to said proxy server.

5. The smart download system of claim 4, further comprising:
a user interface enhancement module coupled to said proxy server.

6. The smart download system of claim 5, further comprising:
a data combining module coupled to said proxy server.

7. A method of downloading internet data using a data interface in a mobile device comprising:
associating a hyper text transfer protocol proxy server with said mobile device;
coupling said hyper text transfer protocol proxy server to a download scheduler at said mobile device; and scheduling a download using said download scheduler that maps said download to said data interface based on a download condition.

8. The method of downloading interne data of claim 7, further comprising:
associating said download condition with said data interface;
triggering download event based on said download condition being satisfied at said data interface; and
sending said download event from said data interface to said hyper text transfer protocol server.

9. The method of downloading internet data of claim 8, wherein said download condition is selected from group consisting of timer expiry condition, data interface availability condition, global positioning system coordinate match condition, data interface pricing condition, and data interface quality of service availability condition.

10. The method of downloading internet data of claim 8, further comprising:
receiving at said hyper text protocol proxy server said download event from said data interface;
initiating said download using said data interface;
receiving said data into said proxy server from said internet;
and delivering said received internet data to a data consumer selected from group consisting of a local storage at said mobile device, and a internet data consumer application at said mobile device.

11. The method of downloading interne data of claim 10, wherein said data consumer application is
selected from group consisting of internet browser application, and other application that can operate upon said interne data.

12. The method of downloading interne data of claim 10, further comprising:
providing user interface to said user to enable scheduling said downloads; and
indicating to said user status of data and associated data interface, wherein said status of data is selected from group consisting of scheduled for download status, download completed status, download partial status, download cancelled status, and download interrupted status.

13. The method of downloading interne content of claim 12, further comprising:
combining references to downloaded data, downloaded data, references to data that can be downloaded in real time, and data that is downloaded in real time, to provide a combined view of all data.

14. A mobile device to provide efficient downloading of internet data across plurality of data interfaces of said mobile device, comprising:
a hyper text transfer protocol proxy server; and a schedule manager software module coupled to said proxy server.

15. The mobile device of claim 14, wherein
said mobile device is selected from group consisting of personal digital assistant smartphone, midrange mobile phone, and portable media player.

16. The mobile device of claim 14, wherein
said data interface is selected from group consisting of cellular packet data interface, wireless local area network interface, bluetooth wireless interface, universal serial bus interface, and ethernet interface.

17. The mobile device of claim 14, further comprising:
a data interface listener software module coupled to said proxy server and said data interfaces.

18. The mobile device of claim 17, further comprising:
a data download manager software module coupled to said proxy server.

19. The mobile device of claim 18, further comprising:
a user interface enhancement module coupled to said proxy server.

20. The mobile device of claim 19, further comprising:
a data combining module coupled to said proxy server.
